(19) United States
(12) Patent Application Publication
(10) Pub. No.: US 2026/0105678 A1
(43) Pub. Date: Apr. 16, 2026

(54) VIDEO IMAGE GENERATION METHOD, ELECTRONIC APPARATUS AND STORAGE MEDIUM

(71) Applicant: Beijing Zitiao Network Technology Co., Ltd., Beijing (CN)

(72) Inventor: Jiacheng LIU, Beijing (CN)

(21) Appl. No.: 19/359,071

(22) Filed: Oct. 15, 2025

(30) Foreign Application Priority Data
Oct. 15, 2024 (CN) 202411441472.0

(51) Int. Cl. G06T 15/04; G06T 3/40; G06T 3/60; G06T 5/50; H04N 21/81

(52) U.S. Cl. CPC G06T 15/04; G06T 3/40; G06T 3/60; G06T 5/50; H04N 21/816; G06T 2207/20221

(57) ABSTRACT

A video image generation method, an electronic apparatus and a storage medium are provided. The video image generation method includes: according to image attribute information of a to-be-processed image and model attribute information of a three-dimensional polyhedron model, fusing the to-be-processed image into the three-dimensional polyhedron model, to obtain a target polyhedron model displayed in a video image; according to the image attribute information and the map attribute of the to-be-rendered texture map, rendering the to-be-processed image into the to-be-rendered texture map, to obtain a target texture map displayed in the video image, wherein the target texture map is a background image, and the target polyhedron model is a foreground image; and in response to that the target polyhedron model reaches a first stop display condition, processing the to-be-processed image, determining the target display image and displaying the target display image in the video image.

### CROSS-REFERENCE TO RELATED APPLICATION

The present application claims the priority to and benefits of the Chinese Patent Application No. 202411441472.0, filed on Oct. 15, 2024, which is incorporated by reference in its entirety.

### TECHNICAL FIELD

Embodiments of the present disclosure relate to a video image generation method, an electronic apparatus and a storage medium.

### BACKGROUND

At present, video production is often required in fields such as animation, video processing, or game development. In the process of video production, it is usually needed to import images into a video template to perform the video producing, and the video template usually includes a canvas, a video main track selected by a user, a video sub-track of the video main track and the like. For example, if the image or video selected by the user is used as the video main track, animation effects can be overlaid on the video main track. Or, other images or videos may be selected as the video sub-track, and animation effects are continuously overlaid on the video sub-track to achieve a picture-in-picture animation effect.

### SUMMARY

The present disclosure provides a video image generation method, an electronic apparatus and a storage medium, aiming to realize that an inputted image is ensured to be adapted with each display plane while the inputted image is displayed with a polyhedral animation effect, thus improving the video display effect.

An embodiment of the present disclosure provides a video image generation method, the method includes: according to image attribute information of a to-be-processed image and model attribute information of a three-dimensional polyhedron model, fusing the to-be-processed image into the three-dimensional polyhedron model, to obtain a target polyhedron model displayed in a video image; according to the image attribute information of the to-be-processed image and map attribute of the to-be-rendered texture map, rendering the to-be-processed image into the to-be-rendered texture map, to obtain a target texture map displayed in the video image, wherein the target texture map is a background image in the video image, and the target polyhedron model is a foreground image in the video image; and in response to that the target polyhedron model reaches a first stop display condition, processing the to-be-processed image according to the image attribute information, the map attribute and the model attribute information, determining a target display image and displaying the target display image in the video image.

An embodiment of the present disclosure provides an electronic apparatus, the electronic apparatus comprises at least one processor and a non-transitory memory with instructions thereon, and the instructions upon execution by the at least one processor, cause the at least one processor to implement a video image generation method as described in any embodiment of the present disclosure.

An embodiment of the present disclosure provides a non-transitory computer-readable storage medium storing instruction, and the instructions upon execution by the at least one processor, cause the at least one processor to implement a video image generation method as described in any embodiment of the present disclosure.

### BRIEF DESCRIPTION OF DRAWINGS

Combining drawings and referring to specific implementation modes below, the above and other features, advantages, and aspects of each embodiment of the present disclosure may become more apparent. Throughout the drawings, the same or similar reference numbers represent the same or similar elements. It should be understood that the drawings are schematic, and members and elements may not be drawn to scale.

FIG. 1 is a flowchart of a video image generation method provided by an embodiment of the present disclosure;

FIG. 2 is a schematic diagram for representing a target texture map involved in an embodiment of the present disclosure;

FIG. 3 is a schematic diagram for representing a target texture map involved in an embodiment of the present disclosure;

FIG. 4 is a flowchart of a video image generation method provided by an embodiment of the present disclosure;

FIG. 5 is a schematic diagram for representing a three-dimensional polyhedron model provided by an embodiment of the present disclosure;

FIG. 6 is a schematic diagram for representing a plane image provided by an embodiment of the present disclosure;

FIG. 7 is a schematic diagram for representing a plane image provided by an embodiment of the present disclosure;

FIG. 8 is a schematic diagram for representing a to-be-used image provided by an embodiment of the present disclosure;

FIG. 9 is a schematic diagram of a video image generation method involved in an embodiment of the present disclosure;

FIG. 10 is a flowchart of a video image generation method provided by an embodiment of the present disclosure;

FIG. 11 is a schematic diagram for representing a target display image provided by an embodiment of the present disclosure;

FIG. 12 is a schematic diagram for representing a target display image provided by an embodiment of the present disclosure;

FIG. 13 is a flowchart of a video image generation method provided by an embodiment of the present disclosure;

FIG. 14 is a schematic structural diagram of a video image generation device provided by an embodiment of the present disclosure; and

FIG. 15 is a schematic structural diagram of an electronic apparatus provided by an embodiment of the present disclosure.

### DETAILED DESCRIPTION

Embodiments of the present disclosure are described in more detail below with reference to the drawings. Although certain embodiments of the present disclosure are shown in the drawings, it should be understood that the present disclosure may be implemented in various forms and should not be construed as being limited to the embodiments described here. On the contrary, these embodiments are provided for more thorough and complete understanding of the present disclosure. It should be understood that the drawings and embodiments of the present disclosure are only for exemplary purposes and are not intended to limit the protection scope of the present disclosure.

It should be understood that various steps recorded in method implementation modes of the present disclosure may be executed in different orders and/or executed in parallel. In addition, the method implementation modes may include additional steps and/or omit executing steps shown. The scope of the present disclosure is not limited in this aspect.

The term “including” and its variations used in the present disclosure are open-ended including, namely “including but not limited to”. The term “based” is “based at least partially”. The term “an embodiment” means “at least one embodiment”; the term “another embodiment” means “at least one additional embodiment”; and the term “some embodiments” means “at least some embodiments”. The relevant definitions of other terms are provided in the following description.

It should be noted that the concepts such as “first” and “second” mentioned in the present disclosure are only used to distinguish different devices, modules, or units, and are not intended to limit the orders of functions executed by these devices, modules, or units or relationships of interdependence thereof.

It should be noted that the modifications of “a”, “an” and “a plurality of” mentioned in the present disclosure are schematic rather than restrictive, and those skilled in the art should understand that unless otherwise explicitly stated in the context, it should be understood as “one or more”.

The names of messages or information exchanged between a plurality of devices in implementation modes of the present disclosure are only for descriptive purposes and are not intended to limit the scope of these messages or information.

It may be understood that before technical solutions disclosed in each embodiment of the present disclosure are used, users should be informed of the types, usage scopes, and usage scenarios and the like of personal information involved in the present disclosure by appropriate means in accordance with relevant laws and regulations, and user authorization should be acquired.

For example, in response to receiving a user's active request, prompt information is sent to the user, and the user is explicitly prompted that an operation being requested to execute by him/her will require acquiring and using the user's personal information. Thus, the user may autonomously select whether to provide the personal information to software or hardware such as an electronic apparatus, an application program, a server, or a storage medium that executes the operations of the technical solutions of the present disclosure according to the prompt information.

As an optional but non-restrictive implementation mode, in response to receiving the user's active request, the way to send the prompt information to the user may be, for example, in the form of a pop-up window, and the prompt information may be presented in the pop-up window in the form of a text. In addition, the pop-up window may also carry a selection control for the user to select whether to “agree” or “disagree” to provide the personal information to the electronic apparatus.

It may be understood that the above informing and acquiring the user authorization processes are only schematic and do not limit the implementation modes of the present disclosure. Other modes that meet the relevant laws and regulations may also be applied to the implementation modes of the present disclosure.

It may be understood that data involved in the present technical solution (including but not limited to the data itself, data acquisition or use) should comply with the requirements of corresponding laws and regulations and relevant provisions.

Before describing this technical solution, the application scenarios will be exemplarily illustrated. The technical solution may be applied in any scenario that requires video production, for example, in any scenario such as animation, video processing, or game development. When it is needed to produce a video animation based on the imported image or video, the technical solution provided by the embodiment of the present disclosure may be adopted.

For example, a video producing manner is usually to adjust the size and position of the imported image in the image, overlay the imported image into the image, and produce the video based on the overlaid image. The connection between the animations in the video produced in this way is poor, which leads to the poor video animation effect.

Exemplarily, users may upload an image of any resolution in an application, and use the image as a to-be-processed image to produce a video animation corresponding to the uploaded image, and display the animation effect of the uploaded image with the video animation.

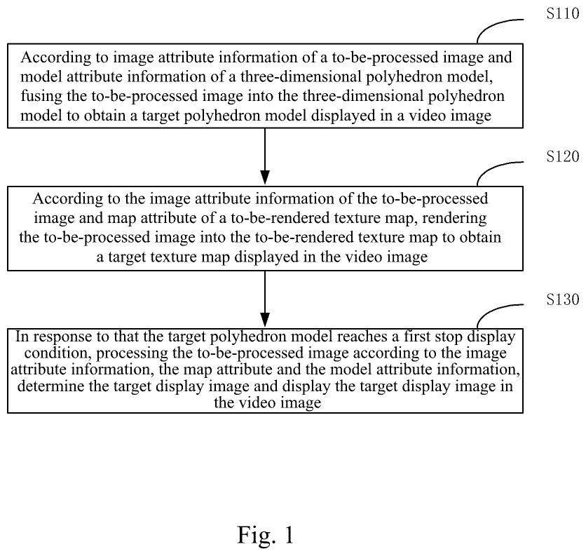

FIG. 1 is a flowchart of a video image generation method provided by an embodiment of the present disclosure. The embodiment of the present disclosure is suitable for any video production scenario. The method may be executed by a video image generation device, and the device may be implemented in a form of software and/or hardware, optionally, implemented by an electronic apparatus which may be a mobile terminal, a PC terminal or a server and the like.

As shown in FIG. 1, the method in the embodiment specifically includes:
S110, according to image attribute information of a to-be-processed image and model attribute information of a three-dimensional polyhedron model, fusing the to-be-processed image into the three-dimensional polyhedron model, to obtain a target polyhedron model displayed in a video image.

The to-be-processed image may refer to any image needing to generate its video animation. The image attribute information may refer to attribute information related to the characteristics of the image, for example, the image attribute information includes but is not limited to image resolution, image aspect ratio, pixel depth, image format, image size, color, texture, hue, saturation, brightness, color channel and the like. The three-dimensional polyhedron model may be a geometry model with any shape structure, and may be composed of vertexes, edges, planes and association relationships among them, for example, the geometry may be a cube, a regular tetrahedron, a pyramid and the like. Optionally, the three-dimensional polyhedron model may be a three-dimensional model of a simulated cubic magic cube, the simulated cubic magic cube refers to a three-dimensional geometric magic cube, the magic cube may be composed of a plurality of small geometries, and each small geometry can move in the magic cube. The model attribute information may refer to attribute information related to the characteristics of the three-dimensional polyhedron model, for example, the model attribute information includes but is not limited to plane aspect ratio, color, hue, saturation, brightness and the like of at least one plane. The target polyhedron model is a model fused with the to-be-processed image.

In the embodiment, when video production based on a certain image is performed, the image may be treated as the to-be-processed image. In order to enable the to-be-processed image to have a three-dimensional display effect of the magic cube, the image attribute information of the to-be-processed image and the model attribute information of the preset three-dimensional polyhedron model may be determined, and the attribute information may be pre-configured and may also be the attribute information obtained after a user adjusts the attribute information. Further, the size or resolution and the like of the to-be-processed image may be properly adjusted in combination with the image attribute information and the model attribute information, so that the adjusted to-be-processed image adapts to the plane of the three-dimensional polyhedron model, and the adjusted to-be-processed image is rendered to the plane of the three-dimensional polyhedron model. The target polyhedron model is determined through the rendered three-dimensional polyhedron model, and thus the to-be-processed image can be displayed by playing the target polyhedron model in the video image. Optionally, the target polyhedron model may be rotationally displayed with a preset rotary animation, for example, the preset rotary animation includes but is not limited to various animation forms such as rotational entering from bottom to top and moving small geometries in the model during model rotating.
S120, according to the image attribute information of the to-be-processed image and map attribute of a to-be-rendered texture map, rendering the to-be-processed image into the to-be-rendered texture map, to obtain a target texture map displayed in the video image.

The to-be-rendered texture map may be a pre-configured map, for example, the map may be a black base image. The map attribute includes but is not limited to map aspect ratio, map resolution, map size, transparency, map size and the like. The target texture map is a background image in the video image, and the target polyhedron model is a foreground image in the video image.

In the embodiment, the resolution or size of the to-be-processed image may be properly adjusted in combination with the image attribute information of the to-be-processed image and the map attribute of the to-be-rendered texture map, so as to make sure that the adjusted to-be-processed image adapts to the map attribute of the to-be-rendered texture map; and the adjusted to-be-processed image is rendered into the to-be-rendered texture map to obtain the target texture map. When the target texture map and the target polyhedron model are simultaneously displayed in the video image, the target texture map is arranged behind the target polyhedron model in the visual space.

It is to be noted that the aspect ratio of a video display window in an actual client is generally inconsistent with the aspect ratio of the uploaded image; in order to display the background image more naturally in the video image, in the process of rendering the to-be-processed image to the to-be-rendered texture map according to the image attribute information of the to-be-processed image and the map attribute of the to-be-rendered texture map, when the image aspect ratio is greater than the map aspect ratio in the map attribute, the to-be-processed image may be rendered into the to-be-rendered texture map in a height alignment manner according to the map height in the map attribute; and when the image aspect ratio is less than the map aspect ratio, the to-be-processed image is rendered into the to-be-rendered texture map in a width alignment manner according to the map width in the map attribute.

The map aspect ratio may be adapted to a window for displaying the video image, for example, the map aspect ratio may be 9:16.

In the embodiment, the image aspect ratio of the to-be-processed image may be compared with the map aspect ratio of the to-be-rendered texture map; if the image aspect ratio is greater than the map aspect ratio, it indicates that the to-be-processed image is a horizontal screen relative to the to-be-rendered texture map, scaling processing may be performed on the to-be-processed image at the moment to align the height of the to-be-processed image with the map height in the map attribute, and the to-be-processed image obtained after height alignment is rendered into the to-be-rendered texture map. if the image aspect ratio is less than the map aspect ratio, it indicates that the to-be-processed image is a vertical screen relative to the to-be-rendered texture map, scaling processing may be performed on the to-be-processed image at the moment to align the width of the to-be-processed image with the map width in the map attribute, and the to-be-processed image obtained after width alignment is rendered into the to-be-rendered texture map.

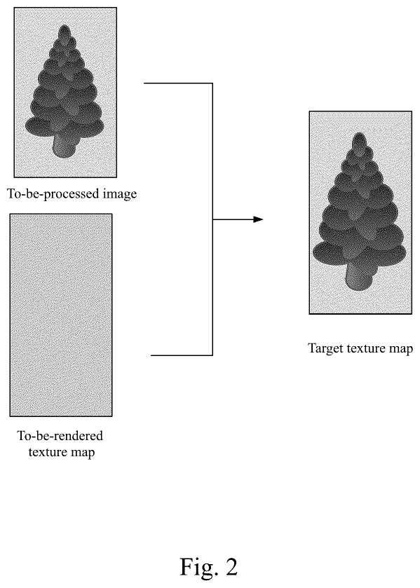

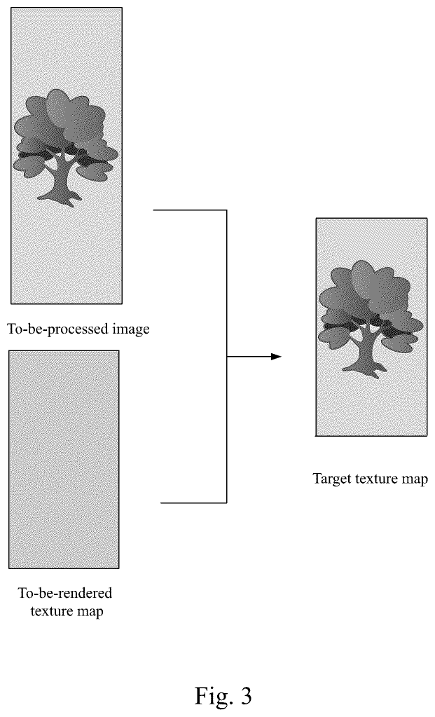

Exemplarily, it is assumed that the map aspect ratio of the to-be-rendered texture map is 9:16, and if the image aspect ratio of the to-be-processed image is 9:13, 9:13 is greater than 9:16, the to-be-processed image may be amplified to be as high as the to-be-rendered texture map, the amplified to-be-processed image is cut and rendered into the to-be-rendered texture map, and the schematic diagram of the obtained target texture map may refer to FIG. 2. If the image aspect ratio of the to-be-processed image is 9:20, 9:20 is less than 9:16, the height of the to-be-processed image may be made the same as the height of the to-be-rendered texture map, the to-be-processed image is cut and rendered into the to-be-rendered texture map, and the schematic diagram of the obtained target texture map may refer to FIG. 3.

According to the technical solution provided by the embodiment of the present disclosure, after aligning the to-be-processed image with the to-be-rendered texture map, the to-be-processed image is rendered into the to-be-rendered texture map, so that the target texture map is used as the background image to display the to-be-processed image; and during playing the video animation, the to-be-processed image can be displayed by the background image while the animation of the target polyhedron model is completely displayed, thus avoiding truncation of the display image, and improving the image display effect.
S130, in response to that the target polyhedron model reaches a first stop display condition, processing the to-be-processed image according to the image attribute information, the map attribute and the model attribute information, determining a target display image and displaying the target display image in the video image.

The first stop display condition may refer to a condition for judging whether to stop displaying the target polyhedron model. The target display image may be the to-be-processed image, or an image obtained by adjusting the to-be-processed image, or an image obtained by fusing the to-be-processed image to a preset plane, or a plane image in the target polyhedron model.

In the embodiment, the first stop display condition may be pre-configured, optionally, the first stop display condition may be that the preset rotary animation is played completely, or, the playing duration reaches a preset duration, or a stop display control is triggered. In the process of rotationally displaying the target polyhedron model according to the preset rotary animation, in response to detecting that the first stop display condition is reached, the to-be-processed image may be processed according to the image attribute information, the map attribute and the model attribute information; for example, the processing operation includes but is not limited to scaling, color matching, matting, compositing, light and dark modification, saturation and chroma modification, adding of setting effects, repairing, and other operations, and the processed image is used as the target display image, and therefore, during displaying the target polyhedron model, the target display image is played at the last image of the video animation.

It is to be noted that the target display image is played in a video window with the video animation effect, and when the video animation dwells in the end in the video window, there may be a position error between the image and the window. In order to solve this problem, in response to that the target display image reaches a second stop display condition and there is a preset display identifier, a corresponding target freeze-frame image is determined after the target display image reaches the second stop display condition based on the to-be-processed image and the map attribute.

The second stop display condition may be a condition for judging whether to stop displaying the target display image, and the condition may be determined according to different requirements, for example, the second stop display condition may be that the target display image is played completely. The preset display identifier may be an identifier which is used to represent whether a freeze-frame image needs to be displayed.

In the embodiment, when the target display image is played completely, it may be detected whether there is the preset display identifier, and if there is the preset display identifier, it indicates that the freeze-frame image needs to be displayed, and at the moment, the to-be-processed image may be processed through the map attribute so as to obtain the target freeze-frame image, and the target freeze-frame image is displayed after the target display image reaches the second stop display condition; and in this way, the display effect can be effectively improved, and the position error between the final freeze-frame image and the window is avoided. If there is not the preset display identifier, the target display image may be directly displayed. Exemplarily, when the last stop position of the video animation is inconsistent with a window image without effects, one identifier (preset display identifier) used for displaying the freeze-frame image may be added in advance. In response to that the video animation is played completely and the preset display identifier is detected, the to-be-processed image may be processed to obtain the target freeze-frame image.

According to the technical solution provided by the embodiment of the present disclosure, the method includes: according to the image attribute information of the to-be-processed image and the model attribute information of the three-dimensional polyhedron model, fusing the to-be-processed image into the three-dimensional polyhedron model to obtain the target polyhedron model displayed in the video image; according to the image attribute information of the to-be-processed image and a map attribute of the to-be-rendered texture map, rendering the to-be-processed image into the to-be-rendered texture map to obtain the target texture map displayed in the video image, in which, the target texture map is the background image in the video image, and the target polyhedron model is the foreground image in the video image; in response to that the target polyhedron model reaches the first stop display condition, processing the to-be-processed image according to the image attribute information, the map attribute and the model attribute information, and determining the target display image and displaying the target display image in the video image; and therefore, the problem that in the related technology, video production is carried out by adjusting the size and the position of the inputted image, which leads to poor video playing effect is solved; and according to the image attribute information of the to-be-processed image and the model attribute information of the three-dimensional polyhedron model, the to-be-processed image is fused into the three-dimensional polyhedron model, which can realize that the to-be-processed image adapts to each plane of the target polyhedron model, and meanwhile, the effect of displaying the inputted image with the polyhedron animation effect is achieved. Moreover, according to the image attribute information of the to-be-processed image and the map attribute of the to-be-rendered texture map, the to-be-processed image is rendered into the to-be-rendered texture map, so that the target texture map is used as the background image to display the inputted image while the inputted image is displayed with the polyhedron animation, the image display truncation is avoided, and the display fluency is improved. Furthermore, in response to that the target polyhedron model reaches the first stop display condition, the to-be-processed image is processed according to the image attribute information, the map attribute and the model attribute information, and the target display image is determined and displayed in the video image, thereby ensuring that the inputted image adapts to each display plane, and at the same time, ensuring that the inputted image of any resolution can be correctly displayed in the corresponding image, thus improving the video display effect.

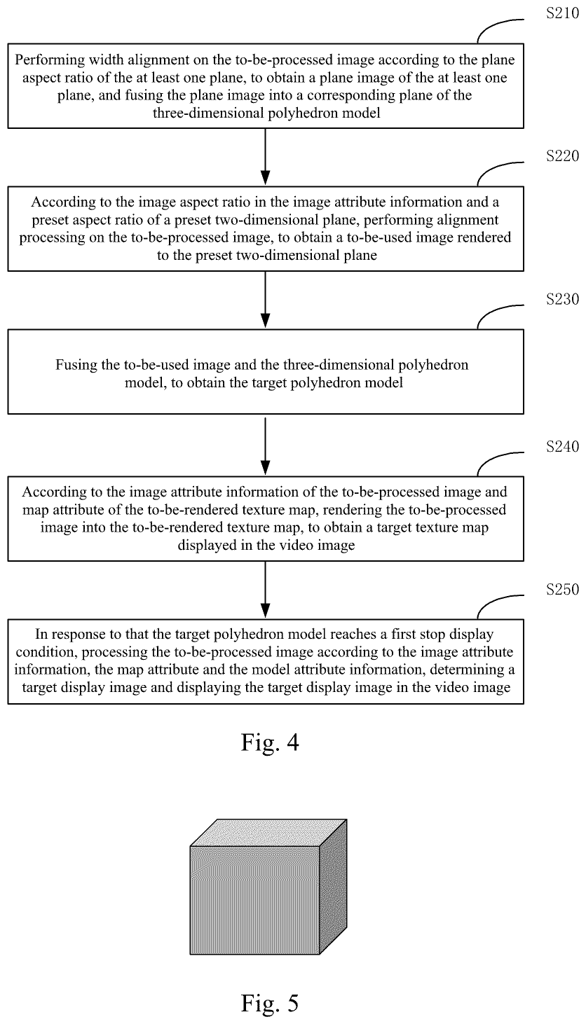

FIG. 4 is a flowchart of a video image generation method provided by an embodiment of the present disclosure. According to the technical solution in the embodiment, on the basis of the above embodiment, the “according to image attribute information of a to-be-processed image and model attribute information of a three-dimensional polyhedron model, fusing the to-be-processed image into the three-dimensional polyhedron model to obtain a target polyhedron model displayed in a video image” is further described, and the specific implementation mode may refer to the detailed description in the embodiment of the present disclosure. The technical features which are the same as or similar to the above embodiment will not be described here.

As shown in FIG. 4, the method in the embodiment may specifically include:
S210, performing width alignment on the to-be-processed image according to the plane aspect ratio of the at least one plane, to obtain a plane image of the at least one plane, and fusing the plane image into a corresponding plane of the three-dimensional polyhedron model.

It is to be noted that the manners of determining the plane image of each plane in the three-dimensional polyhedron model are the same, and determining the plane image of any plane is taken as an example for description.

Specifically, the size of the to-be-processed image may be scaled according to the plane aspect ratio of the plane so as to align the width of the processed to-be-processed image with the width of the plane, the processed to-be-processed image is the plane image of the plane, and the plane image may be rendered into the plane of the three-dimensional polyhedron model. Correspondingly, the to-be-processed image may be displayed by each plane in the three-dimensional polyhedron model through the plane image.

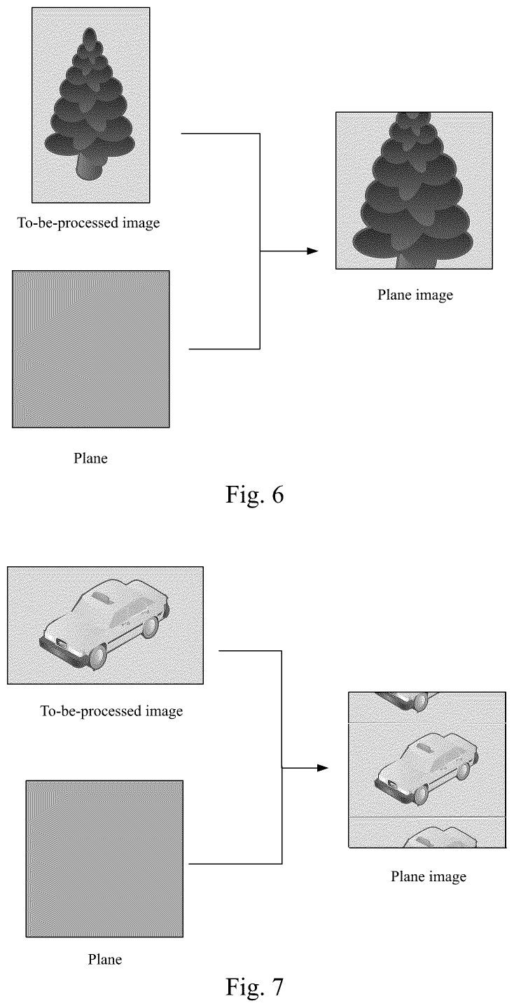

Exemplarily, with reference to FIG. 5, it is assumed that the three-dimensional polyhedron model is a cube, the cube has six planes, and the planes are square. If the to-be-processed image is an image narrower than the plane, the to-be-processed image may be amplified to make the width of the to-be-processed image consistent with the width of the plane; a portion of image in the middle of the to-be-processed image is extracted, and the aspect ratio of the portion of image is consistent with the plane aspect ratio of the plane; and the portion of image is rendered to the plane, and the schematic diagram of the obtained plane image may refer to FIG. 6. If the to-be-processed image is an image wider than the plane, the to-be-processed image may be reduced to make the width of the to-be-processed image consistent with the width of the plane; and at this moment, if the height of the processed to-be-processed image is less than the height of the plane, the processed to-be-processed image may be rendered in the plane, mirror processing is performed on the upper and lower unoccupied portions in the plane by using the to-be-processed image, and the mirror image is rendered to the upper and lower unoccupied portions in the plane, and the schematic diagram of the obtained plane image may refer to FIG. 7.
S220, according to the image aspect ratio in the image attribute information and a preset aspect ratio of a preset two-dimensional plane, performing alignment processing on the to-be-processed image to obtain a to-be-used image rendered to the preset two-dimensional plane.

The preset two-dimensional plane may be a two-dimensional plane which is preset, and the preset two-dimensional plane may have the same width and the same height as the plane in the three-dimensional polyhedron model, namely the preset aspect ratio is the same as the plane aspect ratio.

In the embodiment, the to-be-processed image may be subjected to scaling processing according to the image aspect ratio in the image attribute information and the preset aspect ratio of the preset two-dimensional plane, so as to align the to-be-processed image with the preset two-dimensional plane in width or height, and the to-be-processed image obtained after performing alignment process is rendered to the preset two-dimensional plane to obtain the to-be-used image.

In order to improve the display effect, in the process of according to the image aspect ratio in the image attribute information and the preset aspect ratio of a preset two-dimensional plane, performing alignment processing on the to-be-processed image to obtain a to-be-used image rendered to the preset two-dimensional plane, if the image aspect ratio is less than the preset aspect ratio, the to-be-processed image is subjected to height alignment to obtain a to-be-mirrored image; and performing mirror processing on the to-be-mirrored image in a first direction according to the preset two-dimensional plane so as to obtain the to-be-used image; or, if the image aspect ratio is greater than the preset aspect ratio, the to-be-processed image is subjected to width alignment to obtain the to-be-mirrored image; and performing mirror processing on the to-be-mirrored image in a second direction according to the preset two-dimensional plane so as to obtain the to-be-used image.

The first direction may refer to a direction corresponding to width, the second direction may refer to a direction corresponding to height, for example, on a two-dimensional space coordinate system, an X axis represents width, so the X axis represents the first direction; and a Y axis represents height, so the Y axis represents the second direction.

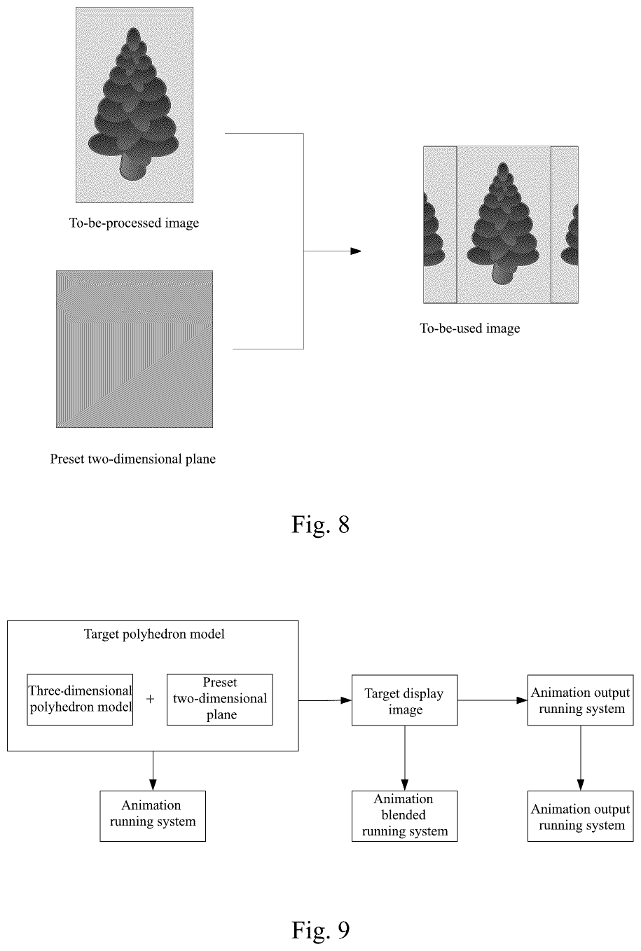

In the embodiment, the image aspect ratio may be compared with the preset aspect ratio, and if the image aspect ratio is less than the preset aspect ratio, it indicates that the to-be-processed image is a vertical screen image, and the height of to-be-processed image may be subjected to height alignment rendering according to the height standard of the preset two-dimensional plane at the moment so as to make the height of the processed to-be-processed image consistent with the height of the two-dimensional plane; and if the width of the processed to-be-processed image is less than that of the plane, the processed to-be-processed image may be rendered in the preset two-dimensional plane, the left edge portion and the right edge portion in the preset two-dimensional plane are subjected to mirror processing to obtain the to-be-mirrored image, the to-be-mirrored image is also rendered to the preset two-dimensional plane, the rendered preset two-dimensional plane is the to-be-used image, and the schematic diagram of the to-be-used image may refer to FIG. 8. If the image aspect ratio is greater than the preset aspect ratio, it indicates that the to-be-processed image is a horizontal screen image, the width of the to-be-processed image may be aligned with the width of the preset two-dimensional plane at the moment, the upper edge portion and the lower edge portion are subjected to mirror processing to obtain the to-be-mirrored image, the to-be-mirrored image is rendered to the preset two-dimensional plane, the rendered preset two-dimensional plane is the to-be-used image, and the to-be-used image is similar to the plane image in FIG. 6. The to-be-processed image is displayed in a mirror image mode, which can effectively improve the display effect; and moreover, the to-be-used image may be used as a connection image for playing the rotary animation of the three-dimensional polyhedron model, thereby further improving the displaying naturalness of the animation, and making the played image have continuity.
S230, fusing the to-be-used image and the three-dimensional polyhedron model to obtain the target polyhedron model.

In the embodiment, the to-be-used image may be bound with the three-dimensional polyhedron model to obtain the target polyhedron model. Exemplarily, with reference to FIG. 9, the target polyhedron model includes the to-be-used image determined based on the preset two-dimensional plane and the three-dimensional polyhedron model fused with the to-be-used image, so that during playing the rotary animation of the target polyhedron model, the to-be-used image is used as final effect display, and the animation can be played naturally.

In order to further improve the video animation presentation effect, a target material may be added to the three-dimensional polyhedron model so as to simulate a preset effect in the process of displaying the target polyhedron model according to the preset rotary animation.

The target material may be a PBR material (Physically Based Rendering, a rendering material based on the physical).

In the embodiment, the physical characteristics of the light rays such as reflection, refraction and scattering may be considered, an interaction state of the light rays and the surface of the three-dimensional polyhedron model may be computed to simulate the rendering of a real world image; and the target material is added to the three-dimensional polyhedron model, so that an image with the illumination effect can be simulated in the process of displaying the target polyhedron model according to the preset rotary animation.

It is to be noted that if the target polyhedron model is continuously displayed with the target material in the process of displaying the target polyhedron model, there may be a problem of poor display effect. For example, it is assumed that each plane of the target polyhedron model is added with the light material (that is, the target material) during animation, and if the playing is performed still with the material at the end of playing the target polyhedron model, the image may be too bright, resulting in the problem of poor visual effect in video playing.

In order to solve this problem and improve the visual effect, the target material of the target polyhedron model may be sequentially adjusted according to the display duration in the process of displaying the target polyhedron model in the video image, so that a preset material is adopted for target polyhedron model when the first stop display condition is reached.

The preset material may be a material type which is not influenced by illumination, such as an Unlit material. The display duration may be a time period preset for displaying the target polyhedron model, the specific duration may be determined according to actual requirements, which is not specifically limited in the embodiment of the present disclosure.

In the embodiment, the target material of the target polyhedron model may be gradually adjusted according to the display duration, that is, the model material may be gradually adjusted to make sure that after the target polyhedron model is stopped playing according to the preset rotary animation, the target polyhedron model is displayed with the preset material, namely, the target polyhedron model at the moment has a display effect which is not influenced by light.
S240, according to the image attribute information of the to-be-processed image and the map attribute of the to-be-rendered texture map, rendering the to-be-processed image into the to-be-rendered texture map to obtain the target texture map displayed in the video image.
S250, in response to that the target polyhedron model reaches the first stop display condition, processing the to-be-processed image according to the image attribute information, the map attribute and the model attribute information, determining the target display image and displaying the target display image in the video image.

According to the technical solution provided by the embodiment of the present disclosure, the to-be-processed image is subjected to width alignment according to the plane aspect ratio of at least one plane to obtain the plane image of at least one plane, and the plane image is fused into the corresponding plane of the three-dimensional polyhedron model. Moreover, the to-be-processed image is aligned according to the image aspect ratio in the image attribute information and the preset aspect ratio of the preset two-dimensional plane, so as to obtain the to-be-used image rendered to the preset two-dimensional plane; and further, the to-be-used image is fused with the three-dimensional polyhedron model to obtain the target polyhedron model, and thus when playing the rotary animation of the target polyhedron model, the to-be-used image is used as the final effect to be displayed, and the animation is played naturally.

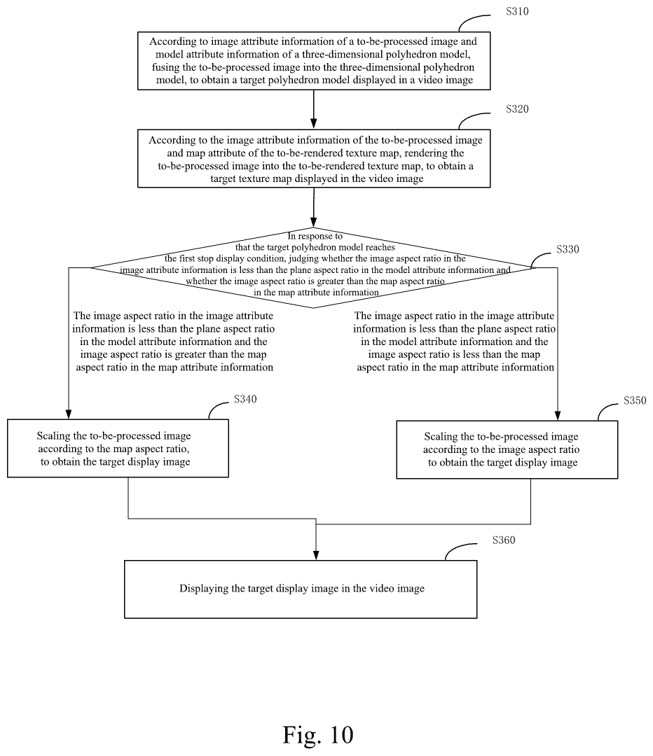

FIG. 10 is a flowchart of a video image generation method provided by an embodiment of the present disclosure. According to the technical solution in the embodiment, on the basis of the above embodiment, the “processing the to-be-processed image according to the image attribute information, the map attribute and the model attribute information, determining a target display image” is further detailed, and the specific implementation mode may refer to the detailed description in the embodiment of the present disclosure. The technical feature which are the same as or similar to the above embodiment will not be repeatedly described here.

As shown in FIG. 10, the method in the embodiment may specifically include:
S310, according to the image attribute information of the to-be-processed image and the model attribute information of the three-dimensional polyhedron model, fusing the to-be-processed image into the three-dimensional polyhedron model, to obtain the target polyhedron model displayed in the video image.
S320, according to the image attribute information of the to-be-processed image and the map attribute of the to-be-rendered texture map, rendering the to-be-processed image into the to-be-rendered texture map to obtain the target texture map displayed in the video image.
S330, in response to that the target polyhedron model reaches the first stop display condition, judging whether the image aspect ratio in the image attribute information is less than the plane aspect ratio in the model attribute information and whether the image aspect ratio is greater than the map aspect ratio in the map attribute information; and if the image aspect ratio in the image attribute information is less than the plane aspect ratio in the model attribute information and the image aspect ratio is greater than the map aspect ratio in the map attribute information, carrying out step S340; and if the image aspect ratio in the image attribute information is less than the plane aspect ratio in the model attribute information and the image aspect ratio is less than the map aspect ratio in the map attribute information, carrying out step S350.

It is to be noted that when playing the target polyhedron model, the target polyhedron model is placed on the background image, and the to-be-processed image is placed on the target polyhedron model, thus presenting an image-in-image visual playing effect. The animation effects of the 3D magic cube animation of the target polyhedron model under inputted images with different aspect ratios are different. In order to ensure the magic cube animation display effect under images with different aspect ratios, the finally displayed image of the target polyhedron model, namely the target display image, may be displayed and played in a manner of scaling the to-be-processed image.

Specifically, the image aspect ratio in the image attribute information may be respectively compared with the plane aspect ratio in the model attribute information and the map aspect ratio in the map attribute information; and if the image aspect ratio is less than the plane aspect ratio and the image aspect ratio is larger than the map aspect ratio, it indicates that the to-be-processed image is the vertical screen with width greater than the map aspect ratio, and step S340 may be carried out at the moment to scale the to-be-processed image. If the image aspect ratio is less than the plane aspect ratio and the image aspect ratio is less than the map aspect ratio, it indicates that the to-be-processed image is the vertical screen with width less than the map aspect ratio, and step S350 may be carried out at the moment to scale the to-be-processed image. If the image aspect ratio is greater than the plane aspect ratio, no processing is carried out.
S340, scaling the to-be-processed image according to the map aspect ratio, to obtain the target display image.

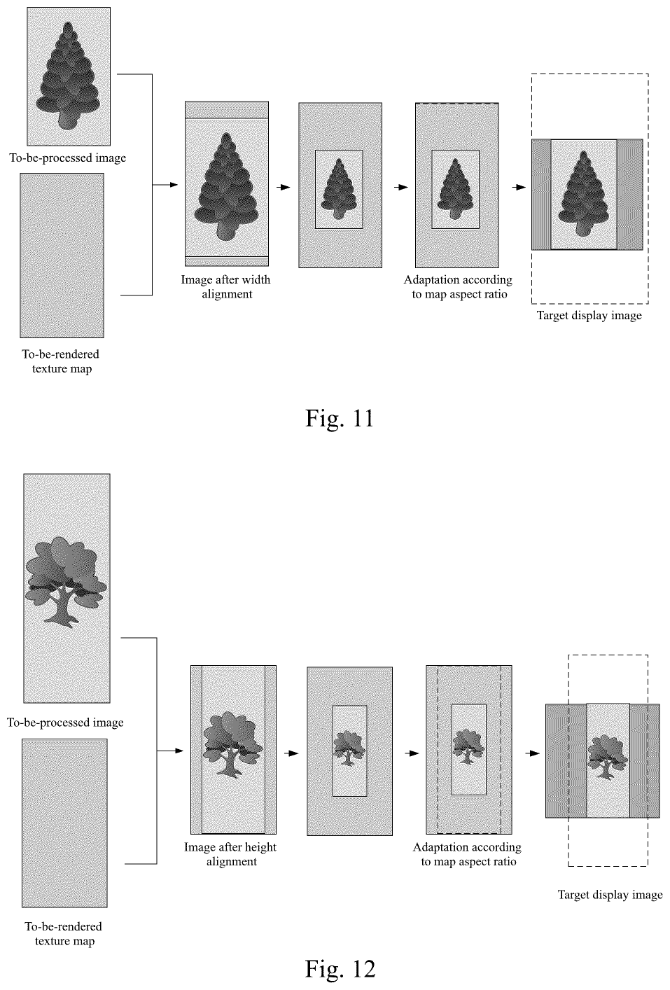

In the embodiment, the to-be-processed image may be performed scaling process according to the map aspect ratio, and the scaled to-be-processed image is the target display image. Exemplarily, it is assumed that the plane in the three-dimensional polyhedron model is square, the plane aspect ratio will be equal to 1, and it is assumed that the map aspect ratio of the to-be-rendered texture map is 9:16. If the image aspect ratio of the inputted image (that is, the to-be-processed image) is 9:13, 9:13 is less than 1, and 9:13 is greater than 9:16, and according to the standard of the map aspect ratio, the to-be-processed image is scaled, and the schematic diagram of the obtained target display image may refer to FIG. 11; and the proportion shown by the dotted line frame in FIG. 11 is the map aspect ratio, and the to-be-processed image is scaled according to the map aspect ratio, thus the final display effect of playing the target polyhedron model can be ensured, and the to-be-processed image can be just displayed in the window.
S350, scaling the to-be-processed image according to the image aspect ratio to obtain the target display image.

In the embodiment, the to-be-processed image may be scaled according to the image aspect ratio, and the scaled to-be-processed image is the target display image. Exemplarily, if the image aspect ratio of the inputted image is 9:20, 9:20 is less than 1, and 9:20 is less than 9:16, and the to-be-processed image is scaled according to the image aspect ratio of 9:20 of the inputted image, and the schematic diagram of the obtained target display image may refer to FIG. 12; and the proportion shown by the dotted line frame in FIG. 12 is the image aspect ratio, and the to-be-processed image is scaled according to the image aspect ratio, so that the final display effect of playing the target polyhedron model can be ensured, and the to-be-processed image can be just displayed in the window.
S360, displaying the target display image in the video image.

According to the technical solution provided by the embodiment of the present disclosure, if the image aspect ratio in the image attribute information is less than the plane aspect ratio in the model attribute information and the image aspect ratio is greater than the map aspect ratio in the map attribute information, the to-be-processed image is scaled according to the map aspect ratio to obtain the target display image. If the image aspect ratio in the image attribute information is less than the plane aspect ratio in the model attribute information and the image aspect ratio is less than the map aspect ratio in the map attribute information, the to-be-processed image is scaled according to the image aspect ratio to obtain the target display image, so that during playing the target polyhedron model corresponding to the image with any aspect ratio, the finally displayed image effect is the same.

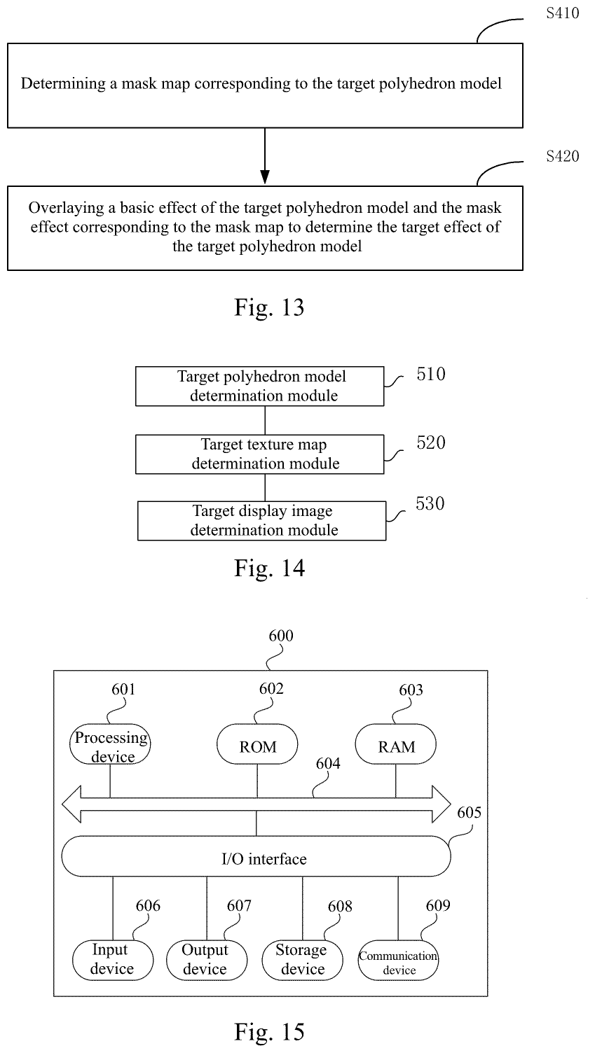

FIG. 13 is a flowchart of a video image generation method provided by an embodiment of the present disclosure. According to the technical solution in the embodiment, on the basis of the above embodiment, a target effect may be added for the target polygonal model, and the specific implementation mode may refer to the detailed description in the embodiment of the present disclosure. The technical feature which are the same as or similar to the above embodiment will not be repeatedly described here.

As shown in FIG. 13, the method in the embodiment may specifically include:
S410, determining a mask map corresponding to the target polyhedron model.

The mask map may be used for controlling the map information of a layer display region and changing the original image information which is expected to be changed, and the mask map includes but is not limited to various types of maps such as a linear mask, a mirror mask, an elliptical mask, a rectangular mask, an love heart mask and a star mask.

In the embodiment, the mask map corresponding to the target polyhedron model may be configured according to the actual video production requirement, and the part needing the effect (such as brightening and light-emitting effect) in the target polyhedron model is provided through the mask map.
S420, overlaying a basic effect of the target polyhedron model and the mask effect corresponding to the mask map to determine the target effect of the target polyhedron model.

The basic effect may be preset, or determined by analyzing the effect of the target polyhedron model after the target polyhedron model is determined. The target effects include light effects and/or edge blurring effects. The light effects include various light-emitting-related effects, such as light and shadow effect simulating shielded light, light ray flying, and light spot flickering effect.

In the embodiment, the target effect of the target polyhedron model may be determined according to the basic effect and a corresponding preset first weight, and the mask effect corresponding to the mask map and a corresponding preset second weight. Specifically, the basic effect may be weighted through the preset first weight to obtain a first weighted effect. The mask effect may be weighted according to the preset second weight of the mask effect to obtain a second weighted effect. The second weighted effect and the basic effect are multiplied to obtain a product value, and the product value is added to the first weighted effect to obtain the target effect.

Exemplarily, light emitting effect of target effect=basic light emitting of basic effect×A %+basic light emitting x mask effect×B %. In which, A % represents the first weight, and B % represents the second weight. In practical application, in order to meet more diverse effects and improve the authenticity of magic cube display, other configuration parameters may be used for rendering different target effects. Optionally, the types of the target effects include but are not limited to light and shadow effect, blurring effect, halation effect and texture effect (such as a brick texture and a wood grain), twisting effect and the like.

It is to be noted that in the basic light-emitting effect, whether to set a light-emitting body in a light-emitting color or keep the light-emitting body as an original state may be determined according to the actual situation. It is also to be noted that the mask map may be selected to follow a screen or follow the three-dimensional model animation to be played according to the actual situation, so that the target effect can be played in the process of rotationally playing the target polyhedron model in the video image.

According to the technical solution provided by the embodiment of the present disclosure, the basic effect of the target polyhedron model and the mask effect corresponding to the mask map are overlaid to add the light effect for the target polyhedron model, thus the visual effect can be enhanced, and the image attraction can be enhanced; and the edge blurring effect is added for the target polyhedron model, so that the image boundary can be softened, and the image can be more natural and softer visually.

FIG. 14 is a schematic structural diagram of a video image generation device provided by an embodiment of the present disclosure, and as shown in FIG. 14, the device includes: a target polyhedron model determination module 510, a target texture map determination module 520 and a target display image determination module 530.

The target polyhedron model determination module 510 is configured to: according to image attribute information of a to-be-processed image and model attribute information of a three-dimensional polyhedron model, fuse the to-be-processed image into the three-dimensional polyhedron model to obtain a target polyhedron model displayed in a video image; the target texture map determination module 520 is configured to: according to the image attribute information of the to-be-processed image and map attribute of a to-be-rendered texture map, render the to-be-processed image into the to-be-rendered texture map to obtain a target texture map displayed in the video image, in which, the target texture map is a background image in the video image, and the target polyhedron model is a foreground image in the video image; and the target display image determination module 530 is configured to: in response to that the target polyhedron model reaches a first stop display condition, process the to-be-processed image according to the image attribute information, the map attribute and the model attribute information, determine a target display image and display the target display image in the video image.

On the basis of the above device, optionally, the image attribute information includes an image aspect ratio, and the model attribute information includes a plane aspect ratio of at least one plane.

On the basis of the above device, optionally, the target polyhedron model determination module 510 includes:
a plane image determination unit, configured to carry out width alignment on the to-be-processed image according to the plane aspect ratio of the at least one plane so as to obtain the plane image of the at least one plane, and fuse the plane image into the corresponding plane of the three-dimensional polyhedron model;
a to-be-used image determination unit, configured to: according to the image aspect ratio in the image attribute information and the preset aspect ratio of a preset two-dimensional plane, perform alignment processing on the to-be-processed image to obtain a to-be-used image rendered to the preset two-dimensional plane; and
a target polyhedron module determination unit, configured to fuse the to-be-used image and the three-dimensional polyhedron model to obtain the target polyhedron model.

On the basis of the above device, optionally, the to-be-used image determination unit is configured to: in response to that the image aspect ratio is less than the preset aspect ratio, perform height alignment on the to-be-processed image to obtain a to-be-mirrored image, and perform mirror processing on the to-be-mirrored image in a first direction according to the preset two-dimensional plane so as to obtain the to-be-used image; or, in response to that the image aspect ratio is greater than the preset aspect ratio, perform width alignment on the to-be-processed image to obtain the to-be-mirrored image, and perform mirror processing on the to-be-mirrored image in a second direction according to the preset two-dimensional plane to obtain the to-be-used image.

On the basis of the above device, optionally, the three-dimensional polyhedron model may be a three-dimensional model of a simulated cubic magic cube; the target polyhedron model is a model fused with the to-be-processed image; and the target polyhedron model is rotationally displayed according to a preset rotary animation.

On the basis of the above device, optionally, the map attribute includes a map aspect ratio; and the target texture map determination module 520 includes:
a first rendering unit, configured to: in response to that the image aspect ratio is greater than the map aspect ratio, render the to-be-processed image into the to-be-rendered texture map in a height alignment manner according to the map height in the map attribute; and
a second rendering unit, configured to: in response to that the image aspect ratio is less than the map aspect ratio, render the to-be-processed image into the to-be-rendered texture map in a width alignment manner according to the map width in the map attribute.

On the basis of the above device, optionally, the target display image determination module 530 includes:
a first scaling unit, configured to: in response to that the image aspect ratio in the image attribute information is less than the plane aspect ratio in the model attribute information and the image aspect ratio is greater than the map aspect ratio in the map attribute information, scale the to-be-processed image according to the map aspect ratio to obtain the target display image; and
a second scaling unit, configured to: in response to that the image aspect ratio in the image attribute information is less than the plane aspect ratio in the model attribute information and the image aspect ratio is less than the map aspect ratio in the map attribute information, scale the to-be-processed image according to the image aspect ratio to obtain the target display image.

On the basis of the above device, optionally, the device further includes:
a target material adding unit, configured to add a target material for the three-dimensional polyhedron model so as to simulate a preset effect in the process of displaying the target polyhedron model according to the preset rotary animation.

On the basis of the above device, optionally, the device further includes:
a target material adjusting unit, configured to adjust the target material of the target polyhedron model sequentially according to the display duration, so that a preset material is adopted for target polyhedron model when the first stop display condition is reached.

On the basis of the above device, optionally, the device further includes: a target effect determination module configured to add a target effect for the target polygonal model; and the target effect determination module includes:
a mask map determination unit, configured to determine a mask map corresponding to the target polyhedron model; and
a target effect determination unit, configured to overlay a basic effect of the target polyhedron model and the mask effect corresponding to the mask map to determine the target effect of the target polyhedron model, in which, the target effect includes a light effect and/or an edge blurring effect.

On the basis of the above device, optionally, the device further includes: a target freeze-frame image determination unit configured to: in response to that the target display image reaches a second stop display condition and there is a preset display identifier, determine a corresponding target freeze-frame image after the target display image reaches the second stop display condition, based on the to-be-processed image and the map attribute.

According to the technical solution in the embodiment of the present disclosure, the method includes: according to the image attribute information of the to-be-processed image and the model attribute information of the three-dimensional polyhedron model, fusing the to-be-processed image into the three-dimensional polyhedron model to obtain the target polyhedron model displayed in the video image; according to the image attribute information of the to-be-processed image and the map attribute of the to-be-rendered texture map, rendering the to-be-processed image into the to-be-rendered texture map to obtain the target texture map displayed in the video image, in which, the target texture map is the background image in the video image, and the target polyhedron model is the foreground image in the video image; in response to that the target polyhedron model reaches the first stop display condition, processing the to-be-processed image according to the image attribute information, the map attribute and the model attribute information, and determining the target display image and displaying the target display image in the video image; and therefore, the problem that in the related technology, video production is carried out by adjusting the size and the position of the inputted image, which leads to poor video playing effect is solved; and according to the image attribute information of the to-be-processed image and the model attribute information of the three-dimensional polyhedron model, the to-be-processed image is fused into the three-dimensional polyhedron model, which can realize that the to-be-processed image adapts to each plane of the target polyhedron model, and meanwhile, the effect of displaying the inputted image with the polyhedron animation effect is achieved. Moreover, according to the image attribute information of the to-be-processed image and the map attribute of the to-be-rendered texture map, the to-be-processed image is rendered into the to-be-rendered texture map, so that the target texture map can be used as the background image to display the inputted image while the inputted image is displayed with the polyhedron animation, the image display truncation is avoided, and the display fluency is improved. Furthermore, in response to that the target polyhedron model reaches the first stop display condition, the to-be-processed image is processed according to the image attribute information, the map attribute and the model attribute information, and the target display image is determined and displayed in the video image, thereby ensuring that the inputted image adapts to each display plane, and at the same time, ensuring that the inputted image of any resolution can be correctly displayed in the corresponding image, thus improving the video display effect.

An environment image generation device provided by the embodiment of the present disclosure may implement the video image generation method provided by any embodiment of the present disclosure, and is provided with functional modules corresponding to the implementation of the method and has beneficial effects.

It is to be noted that each unit and module included in the above-mentioned device are only divided according to the functional logic, but are not limited to the above-mentioned division, as long as the corresponding function can be realized; and in addition, the specific names of each functional unit are only for the convenience of distinguishing them from each other and are not used for limiting the scope of protection of the embodiments of the present disclosure.

FIG. 15 is a schematic structural diagram of an electronic apparatus provided by an embodiment of the present disclosure. As shown in FIG. 15, an electronic apparatus 600 may include a processing device (such as a central processing unit, and a graphic processing unit) 601, which may perform various appropriate actions and processing according to a program stored in a read-only memory (ROM) 602 or a program loaded from a storage device 608 to a Random Access Memory (RAM) 603. In the RAM 603, various programs and data required for operation of the electronic apparatus 600 are also stored. The processing device 601, ROM 602 and RAM 603 are connected to one another through a bus 604. An input/output (I/O) interface 605 is also connected to the bus 604.

Generally, the following devices may be connected to the I/O interface 605: an input device 606 including, for example, a touch screen, a touchpad, a keyboard, a mouse, a camera, a microphone, an accelerometer, and a gyroscope, an output device 607 including, for example, a liquid crystal display (LCD), a loudspeaker, and a vibrator, a storage device 608 including, for example, a magnetic tape, and a hard disk, and a communication device 609. The communication device 609 may allow the electronic apparatus 600 to perform wireless or wired communication with other electronic apparatuses to exchange data. Although the electronic apparatus 600 with various devices is shown in FIG. 15, it is to be understood that it is not needed to implement or possess all the devices shown. Alternatively, it may implement or possess the more or less devices.

Specifically, according to the embodiment of the present disclosure, the process described above with reference to the flow diagram may be achieved as a computer software program. For example, an embodiment of the present disclosure includes a computer program product, it includes a computer program loaded on a non-transient computer-readable medium, and the computer program contains a program code for executing the method shown in the flow diagram. In such an embodiment, the computer program may be downloaded and installed from the network by the communication device 609, or installed from the storage device 608, or installed from ROM 602. When the computer program is executed by the processing device 601, the above functions limited in the method according to the embodiments of the present disclosure are executed.

The names of the messages or information exchanged between a plurality of the devices in the implementation modes of the present disclosure are only for descriptive purposes and are not intended to limit the scopes of these messages or information.

An electronic apparatus provided by the embodiment of the present embodiment and the video image generation method provided by the above embodiment belong to the same inventive concept, and technical details that are not described in detail in the present embodiment may be referred to the above embodiments, and the present embodiment has the same beneficial effects as the above embodiments.

An embodiment of the present disclosure provides a computer storage medium, a computer program is stored on the computer storage medium, and when the program is executed by the processor, the video image generation method provided by the above embodiment is implemented.

It should be noted that the above computer-readable medium in the present disclosure may be a computer-readable signal medium, a computer-readable storage medium, or any combinations of the two. The computer-readable storage medium may be but not limited to, for example, a system, a device or a member of electricity, magnetism, light, electromagnetism, infrared, or semiconductor, or any combinations of the above. More specific examples of the computer-readable storage medium may include but not limited to: an electric connector with one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage member, a magnetic storage member or any suitable combinations of the above. In the present disclosure, the computer-readable storage medium may be any visible medium that contains or stores a program, and the program may be used by an instruction executive system, device or member, or used in combination with it. In the present disclosure, the computer-readable signal medium may include a data signal propagated in a baseband or as a part of a carrier wave, it carries the computer-readable program code. The data signal propagated in this way may adopt various forms, including but not limited to an electromagnetic signal, an optical signal, or any suitable combinations of the above. The computer-readable signal medium may also be any computer-readable medium other than the computer-readable storage medium, and the computer-readable signal medium may send, propagate, or transmit the program used by the instruction executive system, device or member or in combination with it. The program code contained in the computer-readable medium may be transmitted by using any suitable medium, including but not limited to: a wire, an optical cable, a radio frequency (RF) or the like, or any suitable combinations of the above.

In some implementation modes, a client and a server may be communicated by using any currently known or future-developed network protocols such as a HyperText Transfer Protocol (HTTP), and may interconnect with any form or medium of digital data communication (such as a communication network). Examples of the communication network include a local area network (“LAN”), a wide area network (“WAN”), an internet work (such as the Internet), and an end-to-end network (such as an ad hoc end-to-end network), as well as any currently known or future-developed networks.

The computer-readable storage medium may be contained in the electronic apparatus described above, or may be present alone, without being assembled into the electronic apparatus.

The computer-readable medium carries one or more programs, and when the one or more programs are executed by the electronic apparatus, the electronic apparatus is configured to execute the following steps: according to image attribute information of the to-be-processed image and the model attribute information of the three-dimensional polyhedron model, fusing the to-be-processed image into the three-dimensional polyhedron model to obtain the target polyhedron model displayed in the video image;
according to the image attribute information of the to-be-processed image and the map attribute of the to-be-rendered texture map, rendering the to-be-processed image into the to-be-rendered texture map so as to obtain the target texture map displayed in the video image, in which, the target texture map is a background image in the video image, and the target polyhedron model is the foreground image in the video image; and
in response to that the target polyhedron model reaches the first stop display condition, processing the to-be-processed image according to the image attribute information, the map attribute and the model attribute information, determining the target display image and displaying the target display image in the video image.

The computer program code for executing the operation of the present disclosure may be written in one or more programming languages or combinations thereof, the above programming language includes but not limited to object-oriented programming languages such as Java, Smalltalk, and C++, and also includes conventional procedural programming languages such as a “C” language or a similar programming language. The program code may be completely executed on the user's computer, partially executed on the user's computer, executed as a standalone software package, partially executed on the user's computer and partially executed on a remote computer, or completely executed on the remote computer or server. In the case involving the remote computer, the remote computer may be connected to the user's computer by any types of networks, including LAN or WAN, or may be connected to an external computer (such as connected by using an internet service provider through the Internet).

The flow diagrams and the block diagrams in the drawings show possibly achieved system architectures, functions, and operations of systems, methods, and computer program products according to various embodiments of the present disclosure. At this point, each box in the flow diagram or the block diagram may represent a module, a program segment, or a part of a code, the module, the program segment, or a part of the code contains one or more executable instructions for achieving the specified logical functions. It should also be noted that in some alternative implementations, the function indicated in the box may also occur in a different order from those indicated in the drawings. For example, two consecutively represented boxes may actually be executed basically in parallel, and sometimes it may also be executed in an opposite order, which depends on the functions involved. It should also be noted that each box in the block diagram and/or the flow diagram, as well as combinations of the boxes in the block diagram and/or the flow diagram, may be achieved by using a dedicated hardware-based system that performs the specified function or operation, or may be achieved by using combinations of dedicated hardware and computer instructions.

The units described in the embodiments of the present disclosure may be implemented either in software, or in hardware. The names of the units do not form a limitation to the unit itself in some cases, for example, the first acquisition unit may also be described as “a unit that obtains at least two Internet Protocol addresses”.

The functions described above in the specification may be at least partially executed by one or more hardware logic components. For example, non-restrictive exemplary types of the hardware logic component that may be used include: a field programmable gate array (FPGA), an application specific integrated circuit (ASIC), an application specific standard product (ASSP), a system on chip (SOC), a complex programmable logic device (CPLD) and the like.

In the context of the present disclosure, the machine-readable medium may be a visible medium, and it may contain or store a program for use by or in combination with an instruction executive system, device, or apparatus. The machine-readable medium may be a machine-readable signal medium or a machine-readable storage medium. The machine-readable medium may include but not limited to an electronic, magnetic, optical, electromagnetic, infrared, or semiconductor system, device, or apparatus, or any suitable combinations of the above. More specific examples of the machine-readable storage medium may include an electric connector based on one or more wires, a portable computer disk, a hard disk, RAM, ROM, an erasable programmable read-only memory (EPROM or flash memory), an optical fiber, CD-ROM, an optical storage device, a magnetic storage device, or any suitable combinations of the above.

The above description is only the explanation of the exemplary embodiment and the applied technical principles of the present disclosure. It should be understood by those skilled in the art that the disclosure scope involved in the present disclosure is not limited to the technical solution formed by the specific combination of the above technical features, but also contains other technical solutions formed by any combination of the above technical features or their equivalent features without departing from the above disclosure concept. For example, the above features are replaced with technical features with similar functions (but not limited to) disclosed in the present disclosure to form the technical solution.

In addition, although operations are depicted in a specific order, it is not to be understood as requiring these operations to be performed in the specific order in which they are shown or in a sequential order. In some context, multitasking and parallel processing may be beneficial. Similarly, although a number of specific implementation details are included in the above discussion, these should not be understood as limiting the scope of the present disclosure. Some features described in the context of individual embodiments may also be implemented in combination in a single embodiment. Conversely, the various features described in the context of a single embodiment may also be implemented in multiple embodiments individually or in any suitable combination of sub-embodiments.

Although the subject matter has been described by using language specific to structural features and/or method logical actions, it should be understood that the subject matter defined in the attached claims is not necessarily limited to the specific features or actions described above. Rather, the specific features and actions described above are merely example forms of implementing claims.

1. A video image generation method, comprising:
according to image attribute information of a to-be-processed image and model attribute information of a three-dimensional polyhedron model, fusing the to-be-processed image into the three-dimensional polyhedron model, to obtain a target polyhedron model displayed in a video image;
according to the image attribute information of the to-be-processed image and map attribute of a to-be-rendered texture map, rendering the to-be-processed image into the to-be-rendered texture map, to obtain a target texture map displayed in the video image, wherein the target texture map is a background image in the video image, and the target polyhedron model is a foreground image in the video image; and
in response to that the target polyhedron model reaches a first stop display condition, processing the to-be-processed image according to the image attribute information, the map attribute and the model attribute information, determining a target display image and displaying the target display image in the video image.

2. The method according to claim 1, wherein the image attribute information comprises an image aspect ratio, and the model attribute information comprises a plane aspect ratio of at least one plane.

3. The method according to claim 2, wherein, according to the image attribute information of the to-be-processed image and the model attribute information of the three-dimensional polyhedron model, fusing the to-be-processed image into the three-dimensional polyhedron model, to obtain the target polyhedron model displayed in the video image, comprises:
performing width alignment on the to-be-processed image according to the plane aspect ratio of the at least one plane, to obtain a plane image of the at least one plane, and fusing the plane image into a corresponding plane of the three-dimensional polyhedron model;
according to the image aspect ratio in the image attribute information and a preset aspect ratio of a preset two-dimensional plane, performing alignment processing on the to-be-processed image, to obtain a to-be-used image rendered to the preset two-dimensional plane; and
fusing the to-be-used image and the three-dimensional polyhedron model, to obtain the target polyhedron model.

4. The method according to claim 3, wherein performing the alignment processing on the to-be-processed image according to the image aspect ratio in the image attribute information and the preset aspect ratio of the preset two-dimensional plane, to obtain the to-be-used image rendered to the preset two-dimensional plane, comprises:
when the image aspect ratio is less than the preset aspect ratio, performing height alignment on the to-be-processed image to obtain a to-be-mirrored image, and performing mirror processing on the to-be-mirrored image in a direction corresponding to a width according to the preset two-dimensional plane, to obtain the to-be-used image; or,
when the image aspect ratio is greater than the preset aspect ratio, performing width alignment on the to-be-processed image to obtain the to-be-mirrored image, and performing mirror processing on the to-be-mirrored image in a direction corresponding to a height according to the preset two-dimensional plane to obtain the to-be-used image.

5. The method according to claim 1, wherein the three-dimensional polyhedron model is a three-dimensional model of a simulated cubic magic cube, the target polyhedron model is a model fused with the to-be-processed image, and the target polyhedron model is rotationally displayed according to a preset rotary animation.

6. The method according to claim 2, wherein the map attribute comprises a map aspect ratio, and according to the image attribute information of the to-be-processed image and the map attribute of the to-be-rendered texture map, rendering the to-be-processed image into the to-be-rendered texture map, comprises:
when the image aspect ratio is greater than the map aspect ratio, rendering the to-be-processed image into the to-be-rendered texture map in a height alignment manner according to a map height in the map attribute; and
when the image aspect ratio is less than the map aspect ratio, rendering the to-be-processed image into the to-be-rendered texture map in a width alignment manner according to a map width in the map attribute.

7. The method according to claim 2, wherein processing the to-be-processed image according to the image attribute information, the map attribute and the model attribute information, determining the target display image, comprises:
when the image aspect ratio in the image attribute information is less than the plane aspect ratio in the model attribute information and the image aspect ratio is greater than a map aspect ratio in the map attribute information, scaling the to-be-processed image according to the map aspect ratio, to obtain the target display image; and
when the image aspect ratio in the image attribute information is less than the plane aspect ratio in the model attribute information and the image aspect ratio is less than the map aspect ratio in the map attribute information, scaling the to-be-processed image according to the image aspect ratio, to obtain the target display image.

8. The method according to claim 1, further comprising:
adding a target material for the three-dimensional polyhedron model, to simulate a preset effect in a process of displaying the target polyhedron model according to a preset rotary animation.

9. The method according to claim 8, wherein, in the process of displaying the target polyhedron model according to the preset rotary animation, the method further comprises:
adjusting the target material of the target polyhedron model sequentially according to a display duration, so that a preset material is adopted for the target polyhedron model when the first stop display condition is reached.

10. The method according to claim 1, further comprising:
adding a target effect for the target polygonal model; and
adding the target effect for the target polygonal model, comprises:
determining a mask map corresponding to the target polyhedron model; and
overlaying a basic effect of the target polyhedron model and a mask effect corresponding to the mask map to determine the target effect of the target polyhedron model,
wherein the target effect comprises a light effect and/or an edge blurring effect.

11. The method according to claim 1, further comprising:
in response to that the target display image reaches a second stop display condition and a preset display identifier is detected, determining a corresponding target freeze-frame image after the target display image reaches the second stop display condition, based on the to-be-processed image and the map attribute.

12. An electronic apparatus, comprising:
at least one processor; and
a non-transitory memory with instructions thereon,
wherein the instructions upon execution by the at least one processor, cause the at least one processor to implement a video image generation method, and the video image generation method comprises:
according to image attribute information of a to-be-processed image and model attribute information of a three-dimensional polyhedron model, fusing the to-be-processed image into the three-dimensional polyhedron model, to obtain a target polyhedron model displayed in a video image;
according to the image attribute information of the to-be-processed image and map attribute of a to-be-rendered texture map, rendering the to-be-processed image into the to-be-rendered texture map, to obtain a target texture map displayed in the video image, wherein the target texture map is a background image in the video image, and the target polyhedron model is a foreground image in the video image; and
in response to that the target polyhedron model reaches a first stop display condition, process the to-be-processed image according to the image attribute information, the map attribute and the model attribute information, determining the target display image and display the target display image in the video image.

13. The electronic apparatus according to claim 12, wherein the image attribute information comprises an image aspect ratio, and the model attribute information comprises a plane aspect ratio of at least one plane.

14. The electronic apparatus according to claim 13, wherein, according to the image attribute information of the to-be-processed image and the model attribute information of the three-dimensional polyhedron model, fusing the to-be-processed image into the three-dimensional polyhedron model, to obtain the target polyhedron model displayed in the video image, comprises:
performing width alignment on the to-be-processed image according to the plane aspect ratio of the at least one plane, to obtain a plane image of the at least one plane, and fusing the plane image into a corresponding plane of the three-dimensional polyhedron model;
according to the image aspect ratio in the image attribute information and a preset aspect ratio of a preset two-dimensional plane, performing alignment processing on the to-be-processed image, to obtain a to-be-used image rendered to the preset two-dimensional plane; and
fusing the to-be-used image and the three-dimensional polyhedron model, to obtain the target polyhedron model.

15. The electronic apparatus according to claim 14, wherein performing the alignment processing on the to-be-processed image according to the image aspect ratio in the image attribute information and the preset aspect ratio of the preset two-dimensional plane, to obtain the to-be-used image rendered to the preset two-dimensional plane, comprises:
when the image aspect ratio is less than the preset aspect ratio, performing height alignment on the to-be-processed image to obtain a to-be-mirrored image, and performing mirror processing on the to-be-mirrored image in a direction corresponding to a width according to the preset two-dimensional plane, to obtain the to-be-used image; or,
when the image aspect ratio is greater than the preset aspect ratio, performing width alignment on the to-be-processed image to obtain the to-be-mirrored image, and performing mirror processing on the to-be-mirrored image in a direction corresponding to a height according to the preset two-dimensional plane to obtain the to-be-used image.

16. The electronic apparatus according to claim 12, wherein the three-dimensional polyhedron model is a three-dimensional model of a simulated cubic magic cube, the target polyhedron model is a model fused with the to-be-processed image, and the target polyhedron model is rotationally displayed according to a preset rotary animation.

17. The electronic apparatus according to claim 13, wherein the map attribute comprises a map aspect ratio, and according to the image attribute information of the to-be-processed image and the map attribute of the to-be-rendered texture map, rendering the to-be-processed image into the to-be-rendered texture map, comprises:
when the image aspect ratio is greater than the map aspect ratio, rendering the to-be-processed image into the to-be-rendered texture map in a height alignment manner according to a map height in the map attribute; and
when the image aspect ratio is less than the map aspect ratio, rendering the to-be-processed image into the to-be-rendered texture map in a width alignment manner according to a map width in the map attribute.

18. The electronic apparatus according to claim 13, wherein processing the to-be-processed image according to the image attribute information, the map attribute and the model attribute information, determining the target display image, comprises:
when the image aspect ratio in the image attribute information is less than the plane aspect ratio in the model attribute information and the image aspect ratio is greater than a map aspect ratio in the map attribute information, scaling the to-be-processed image according to the map aspect ratio, to obtain the target display image; and
when the image aspect ratio in the image attribute information is less than the plane aspect ratio in the model attribute information and the image aspect ratio is less than the map aspect ratio in the map attribute information, scaling the to-be-processed image according to the image aspect ratio, to obtain the target display image.

19. The electronic apparatus according to claim 12, wherein the method further comprises:
adding a target material for the three-dimensional polyhedron model, to simulate a preset effect in a process of displaying the target polyhedron model according to a preset rotary animation.

20. A non-transitory computer-readable storage medium storing instructions, wherein the instructions upon execution by the at least one processor, cause the at least one processor to implement a video image generation method, and the video image generation method comprises:
according to image attribute information of a to-be-processed image and model attribute information of a three-dimensional polyhedron model, fusing the to-be-processed image into the three-dimensional polyhedron model, to obtain a target polyhedron model displayed in a video image;
according to the image attribute information of the to-be-processed image and the map attribute of the to-be-rendered texture map, rendering the to-be-processed image into the to-be-rendered texture map, to obtain a target texture map displayed in the video image, wherein the target texture map is a background image in the video image, and the target polyhedron model is a foreground image in the video image; and
in response to that the target polyhedron model reaches a first stop display condition, processing the to-be-processed image according to the image attribute information, the map attribute and the model attribute information, determining the target display image and displaying the target display image in the video image.
